(19) United States
(12) Patent Application Publication
(10) Pub. No.: US 2007/0083711 A1
(43) Pub. Date: Apr. 12, 2007

(54) Reconfiguring caches to support metadata for polymorphism

(75) Inventors: Jeffrey P. Bradford, Rochester, MN (US); Richard J. Eickemeyer, Rochester, MN (US); Timothy H. Heil, Rochester, MN (US); Harold F. Kossman, Rochester, MN (US); Timothy J. Mullins, Rochester, MN (US)

Correspondence Address: Robert R. Williams;IBM Corporation, Dept. 917, 3605 Highway 52 North, Rochester, MN, 55901-7829, US

(73) Assignee: International Business Machines Corporation, Armonk, NY (US)

(21) Appl. No.: 11/246,818

(22) Filed: Oct. 7, 2005

(51) Int. Cl. G06F 12/00

(52) U.S. Cl. 711/118

(57) ABSTRACT

In a method of using a cache in a computer, the computer is monitored to detect an event that indicates that the cache is to be reconfigured into a metadata state. When the event is detected, the cache is reconfigured so that a predetermined portion of the cache stores metadata. A computational circuit employed in association with a computer includes a cache, a cache event detector circuit, and a cache reconfiguration circuit. The cache event detector circuit detects an event relative to the cache. The cache reconfiguration circuit reconfigures the cache so that a predetermined portion of the cache stores metadata when the cache event detector circuit detects the event.

### BACKGROUND OF THE INVENTION

1. Field of the Invention

The present invention relates to integrated circuit memory devices and, more specifically, to a system for managing a cache.

2. Description of the Prior Art

Almost all current high-performance computer processors and most current embedded processors include caches (such as instruction caches and data caches) to improve performance. The geometry of these caches (e.g., their size, associativity, and latency) is determined by making tradeoffs over a range of applications. Each application has potentially different cache usage characteristics. For example, most commercial applications, such as TPC-C, make very heavy use of the instruction cache, whereas other applications, such as SPEC CPU 2000, may have near zero instruction cache misses for current sized L1 instruction caches (i.e. 32-64 kB). Because the cache geometry is based on a tradeoff over a range of applications, some applications will not fully utilize the caches all the time.

One current solution to this problem is to accept underutilized resources as a fact of processor design. This solution, however, leads to increased chip cost when the chip size is larger than needed when resources are underutilized for a particular application or decreased performance when structures are smaller than needed for a particular application.

Another potential solution is to reconfigure the cache geometry in response to the demands made on the cache. However, this solution is not currently done due to the timing issues involved in designing reconfigurable caches.

Metadata is data that is not a direct part of a computation, but rather that includes additional information about an instruction or a data value. Metadata may used after an instruction or a data value has been fetched to improve performance of the processor. Currently, there is no mechanism to associate metadata with the contents of the cache when the cache is otherwise under utilized.

Therefore, there is a need for a method of using unused portions of a cache to store metadata associated with the contents of the cache.

### SUMMARY OF THE INVENTION

The disadvantages of the prior art are overcome by the present invention which, in one aspect, is a method of using a cache in a computer, in which the computer is monitored to detect an event that indicates that the cache is to be reconfigured into a metadata state. When the event is detected, the cache is reconfigured so that a predetermined portion of the cache stores metadata.

In another aspect, the invention is a computational circuit employed in association with a computer. The computational circuit includes a cache, a cache event detector circuit, and a cache reconfiguration circuit. The cache event detector circuit detects an event relative to the cache. The cache reconfiguration circuit reconfigures the cache so that a predetermined portion of the cache stores metadata when the cache event detector circuit detects the event.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a block diagram showing a cache configured to accept metadata in a first way.

FIG. 2 is a block diagram showing a cache configured to accept metadata in a second way.

FIG. 3 is. a block diagram showing a cache configured to accept metadata in a third way.

FIG. 4 is a flow chart showing operation of cache control circuitry.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The present invention uses otherwise underutilized cache storage to store metadata. When storing metadata, the invention associates the normally stored cache data (which include instructions or data) with the metadata. Metadata may encompass additional information relative to the stored instructions or data and is typically used to improve processor performance. When the cache is underutilized, it may be partitioned dynamically to store information about each associated instruction or data value. The metadata is typically used after the cache data are fetched or read to increase performance over the level that would otherwise be achieved without the metadata.

In a typically embodiment, the processor will begin program execution in a “normal” mode. In this mode, the entire cache space is used to store cache data, as is done in current processors. At some point during the program execution, an event occurs that indicates that there would be an advantage in configuring part of the cache to include metadata in addition to the cache data stored in the cache.

When a preselected condition is met, the processor configures the cache into one of possibly several metadata modes. Such a condition could be something as simple as detection of underutilization of the cache (such as a sustained hit rate below a predetermined level) or something more complicated, such as a programmed indication that a routine is of a type that would benefit from the use of metadata and that the routine is about to commence.

Once the decision is made to reconfigure the cache, the instruction cache fetch circuitry or data cache access circuitry is then configured into a new mode in which the cache now contains both cache data and metadata. From that point forward, whenever the cache is accessed, in addition to fetching the requested cache data, the associated metadata are also fetched and provided to the processor. It may be the case that at some further execution point, it is decided that now there is a preference to return to “normal” mode, which results in the use all of the cache exclusively for cache data rather than partially for metadata. In one embodiment, it is possible that a condition will occur (for example, the end of a routine that uses metadata) in which the cache should be reconfigured into a mode that does not use metadata. Similarly, a condition might occur that would cause the cache to be reconfigured to store metadata in a way different from the way it is currently storing it (for example to hold different amounts or different types of metadata, as the program characteristics dictate).

There are several mechanisms that can control the decision to reconfigure the cache to include metadata. In one example, the code controlling the processor includes tests to determine if a preselected condition is met. This can occur through several approaches, including: the use programmed hints or commands in the program microcode, operating system evaluation, and even through logic circuit design and other hardware-based mechanisms.

When a cache is reconfigured to include metadata, the old contents of the cache (the instructions or data) are not changed: the cache is merely reconfigured to have less capacity for them. Thus, the same instructions or data are read out from the cache and they are not modified to hold the metadata. Instead, separate cache space is used to hold the metadata.

A few representative examples of metadata uses that could be employed with the invention include the following: (1) branch prediction information (for example, where the metadata indicates which of a choice of several branches is most likely to be selected, or where the metadata indicates a fetch at a following address instead of fetching at a sequential address, or where the metadata indicates prediction of whether a branch is taken or not taken to allow faster taken-branch redirect time); (2) instruction scheduling information (for example, the metadata could indicate whether an instruction is likely to flush or stall for many cycles, so that the processor could handle the instruction accordingly; (3) microcode information (for example, the metadata could include a starting address in the microcode ROM to allow starting an the instruction sequence sooner); (4) load hit confidence (for example, the metadata could include information that assists processors that do hardware instruction scheduling, by scheduling the use of the load data even later than when the data would be available on a L1 data cache hit); (5) value prediction data (for example, the metadata could include a speculative value used when a given load misses). Similarly, the metadata could be used to indicate value prediction confidence; (6) prefetch information (for example, when a cache line or data value is accessed, the metadata could supply prefetch data or a or prefetch address); (7) replacement information (for example, the metadata could specify how often the associated data is accessed to allow a more intelligent replacement algorithm); and (8) coherence hints (for example, the metadata could be used to either update or to invalidate a cache line in other processors' caches when this line or data value is updated in a multiprocessor system with hardware coherence). As discussed above, this invention is applicable to both the instruction cache and the data cache. In the first five examples presented above, the metadata are associated with instructions, while in the last three examples, the metadata are associated with data. As is readily understood, this is just a representative list and many more metadata applications may be used within the scope of the invention.

There are several ways to create metadata that can be used with the invention. A representative list of examples includes: (1) pre-decode the metadata—once the cache data are loaded into the cache, specialized circuitry reads the cache data and creates the associated metadata; (2) history—after an instruction has been executed one or more times, logic circuitry in the pipeline creates the metadata and stores it in the cache, to be read the next time the instruction is executed; (3) software—during some part of a binary creation (e.g. compilation, linking, runtime), a software routine is executed that creates the metadata and stores it into the cache.

There are several approaches to reconfiguring the cache to share cache space between cache data and metadata, and how to provide the metadata to rest of the processor. Examples of the approaches include:

(1) By set—in this example, one or more of the “sets” of a cache may be used for metadata rather than for cache data. This offers the advantages of not requiring a change to tag structure and it is especially useful when the cache has four-way (or higher) associativity because it allows finer granularity in reducing the cache size. However, this mechanism could result in a slight additional decrease in performance over other mechanisms as both size and associativity of cache is reduced. This mechanism can not be used for direct mapped caches. Also, if data from multiple sets are read out simultaneously and “late selected,” then no addition cache data ports are required. However, an additional or wider data path from the cache to the rest of the pipeline may be required.

(2) By address—in this implementation, some cache lines are used for instructions or data, and some are used for metadata. This offers the advantage of their being less of a decrease in performance, as associativity is unchanged—which is especially beneficial for low associativity caches. However, this mechanism may require a change to tag structure (as the tag width may need to be increased) to account for the fact that there are fewer lines. It might also require an additional cache port to read both cache data (instructions or data) and metadata. Also, due to indexing schemes in caches, a smallest increment is likely to result in half cache data, half metadata being stored.

(3) Within a line—in this implementation, the effective line size is decreased by mixing cache data in with the metadata in the same cache line. This mechanism offers the advantages in that it may not require a change to data path, it would result in no loss of associativity, and it would allow for very fine control over mixing of cache data with metadata. However, it would require a change to tag structure in which the tag width would need to be increased to account for the fact that the line size would be smaller. This implementation would use the existing cache bandwidth to transfer both cache data and metadata. Hence, it is especially appropriate when the cache bandwidth, in addition to the cache storage space, is underutilized, as it would require minimal changes to the data path.

(4) By time—in this implementation, the cache is accessed multiple times (most likely twice) for each instruction: once to get the instructions themselves and a second time to get the metadata. This offers an advantage in that potentially there would not be a change to cache structure or data path. However, it would apply only to caches that are underutilized in terms of both capacity and access frequency. In the case that the cache can not be accessed for the metadata in time, the metadata could just be skipped and the processor would proceed as if there were no metadata available.

(5) By adding ports—in this implementation, extra cache ports and data paths are added to the cache, thereby allowing accessing of both the cache data and the metadata simultaneously. This implementation would offer the advantage that there would be no decrease in performance (with the exception of smaller cache space). However, it could result in a significant increase in the physical size of cache.

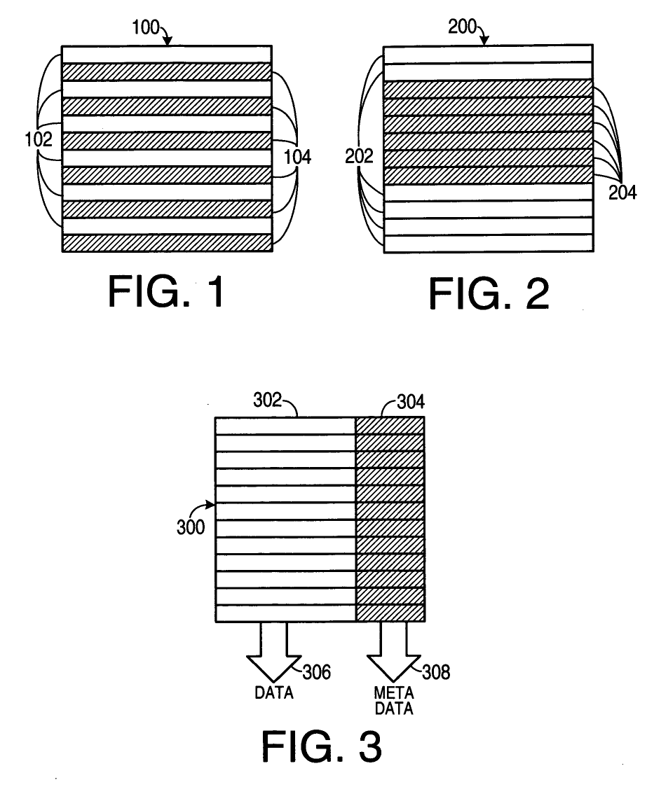

As shown in FIG. 1, one embodiment of the invention includes a cache 100. The cache 100 includes a plurality of cache lines 102 and 104. In the configuration shown, the cache 100 is configured so that each instruction/data line 102 is followed by a cache line 104 dedicated to metadata. As shown in FIG. 2, in one configuration of a cache 200, data/instruction cache lines 202 remain in groups, and the metadata cache lines 204 are also grouped together. As shown in FIG. 3, in another configuration of a cache 300, each cache line includes a data/instruction portion 302 and a metadata portion 304. This configuration could be especially applicable to a multi-port cache where one port 306 is used for instructions or data and another port 308 is used for metadata.

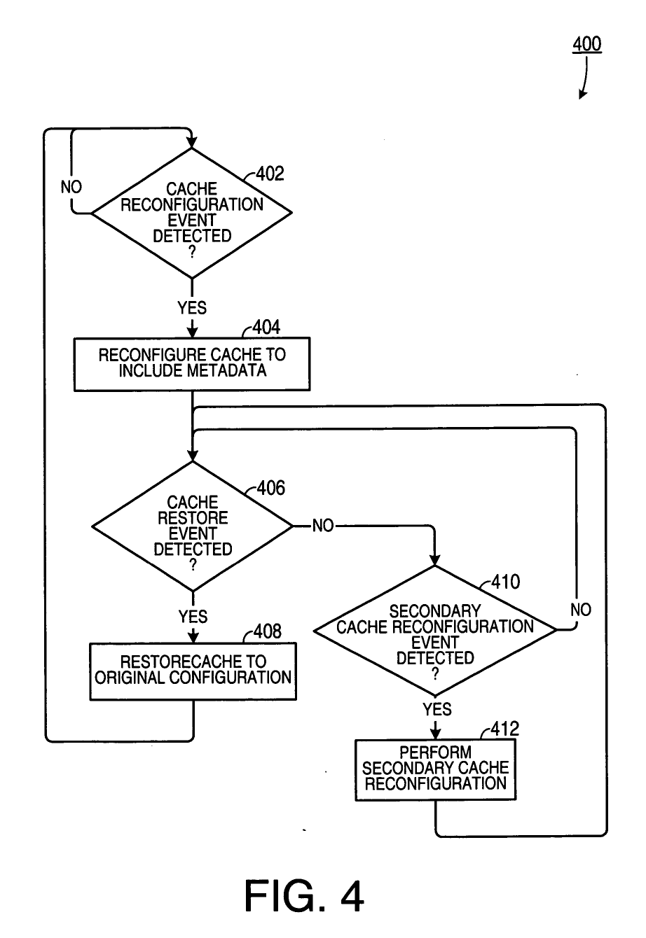

One possible embodiment for a portion of the logic used to operate a cache is shown in FIG. 4. This logic could take the form a program steps, such as in the processor microcode, in the form of logic circuitry, or some combination of the two. The system waits until a cache reconfiguration event is detected 402 and then reconfigures the cache 404 to include metadata. A cache reconfiguration event would be the occurrence of an event of a predetermined type that would indicate that reconfiguration of the cache would be desirable. The system may even determine that it would be advantageous to reconfigure the cache to accept metadata before a program even starts running, based on an evaluation of the program. In this situation the cache reconfiguration event would include an evaluation, prior to the execution of the program, that using metadata would be advantageous. They system then determines if a cache restore event has occurred 406 (e.g., execution reaching the end of a routine that uses metadata or detection of an increase in cache utilization). If “yes,” then the cache is restored to its original (non-metadata) configuration and then the system waits for a next cache reconfiguration event. If “no” (and if more than one metadata configuration is employed), then the system determines if it should go into a different metadata configuration 410 from its current metadata configuration. If “yes,” then it performs a secondary cache configuration 412 to enter the next indicated metadata configuration.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of using a cache in a computer, including the steps of:
a. monitoring the computer to detect an event that indicates that the cache is to be reconfigured into a metadata state; and
b. when the event is detected, reconfiguring the cache so that a predetermined portion of the cache stores metadata.

2. The method of claim 1, wherein the event comprises an indication that the cache is utilized at less that a predetermined level.

3. The method of claim 1, wherein the event comprises an execution of an instruction directing the cache to be reconfigured.

4. The method of claim 1, wherein the event comprises commencement of a predetermined routine.

5. The method of claim 1, wherein the reconfiguring step comprises designating a preselected number of cache lines as metadata lines.

6. The method of claim 1, wherein the reconfiguring step comprises designating a preselected portion of each cache line as a metadata portion.

7. The method of claim 1, wherein the metadata comprises instruction-related information.

8. The method of claim 7, wherein the instruction-related data includes an indication of a branch prediction.

9. The method of claim 7, wherein the instruction-related data includes information regarding the scheduling of an instruction.

10. The method of claim 7, wherein the instruction-related data includes information regarding use of microcode.

11. The method of claim 7, wherein the instruction-related data includes an indication of cache load hit confidence.

12. The method of claim 7, wherein the instruction-related data includes value prediction information.

13. The method of claim 1, wherein the metadata comprises data-related information.

14. The method of claim 13, wherein the data-related information includes data prefetch information.

15. The method of claim 13, wherein the data-related information includes data replacement information.

16. The method of claim 13, wherein the data-related information includes coherency data.

17. A computational circuit, employed in association with a computer, comprising:
a. a cache;
b. a cache event detector circuit that detects an event relative to the cache;
c. a cache reconfiguration circuit that reconfigures the cache so that a predetermined portion of the cache stores metadata when the cache event detector circuit detects the event.

18. The computational circuit of claim 17, wherein the cache comprises:
a. at least one data port, through which data may be accessed; and
b. at least one metadata port, through which metadata may be accessed.
